(19) United States
(12) Patent Application Publication
(10) Pub. No.: US 2009/0252839 A1
(43) Pub. Date: Oct. 8, 2009

(54) Concentrate for preparing a bouillon, soup, sauce, gravy or for use as a seasoning, the concentrate comprising particulates and xanthan and locust bean gum

(76) Inventors: Georg Achterkamp, Heilbronn (DE); Dieter Kurt Karl Ackermann, Heilbronn (DE); Chiharu Inoue, Vlaardingen (NL); Reinhard Kohlus, Heilbronn (DE); Matthias Kuhn, Heilbronn (DE)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/990,968

(22) PCT Filed: Dec. 7, 2006
(86) PCT No.: PCT/EP2006/012061

§ 371 Date: Jul. 7, 2008

(30) Foreign Application Priority Data
Dec. 12, 2005 (EP) 05077842.2
Jun. 7, 2006 (EP) 06115093.4

(51) Int. Cl. A23L 1/40; B65D 85/72; A23L 1/0522

(52) U.S. Cl. 426/106; 426/578

(57) ABSTRACT

Concentrates for preparing a bouillon, broth, soup, sauce, gravy or for use as a seasoning, which concentrates comprises 20-80% water, 0.5-60% (pieces of) herbs, vegetables, meat, fish or crustaceans, 3-30% salt and a gelling agent comprising xanthan and locust bean gum.

### FIELD OF THE INVENTION

The present invention relates to concentrates for preparing a bouillon, broth, soup, sauce, gravy or for use as a seasoning. More in particular, the invention relates to such concentrates which allow the inclusion of herbs, vegetables, meat, fish or crustaceans which are not completely dry.

### BACKGROUND OF THE INVENTION

Concentrates for preparing a bouillon, broth, soup, sauce, gravy, or for use as seasoning are well known in the western and non-western cooking. For brevity, such formulations are herein all abbreviated to “concentrates for preparing a bouillon or for use as a seasoning”.

Conventionally, bouillon and seasoning cubes or tablets comprise ingredients such as one or more of salt, sugar, flavour enhancers (like e.g. monosodium glutamate, MSG), herbs, spices, vegetable particulates, colourants and flavourants, next to e.g. 0-40% (for seasoning cubes 1-60%, for seasonings and bouillon cubes typically 0-20%) fat and/or oil. Salt is usually an ingredient which is present in large amounts, e.g. 5-60%.

Such concentrates are conveniently available in the form of rigid or plastic (i.e. deformable) cubes, tablets, crumbly cubes, or as powders, granules, etcetera. These formulations are known as being dry: a moisture content of less than 8%, usually even lower.

Although such dry formulations have advantages in terms of e.g. preservation, they do require all the ingredients to be dry. If ingredients used in such concentrates are not directly available in a dry form (e.g. herbs and vegetables and pieces thereof, pieces of meat), such ingredients need to be dried first. Needless to say, such is both a hassle as well as that it can have a negative impact on the quality of (pieces of) such herbs, vegetables and meat. Hence, there is a need for concentrates for use as seasoning or for preparing a bouillon, broth, soup, sauce, or gravy, which concentrate would allow the use of ingredients, such as for example herbs and/or vegetables and/or fruits or particles thereof as well as pieces of meat, fish or crustaceans, to be in a not completely dry state, i.e. more than 8% (by weight of the herb/vegetable) moisture. Preferably, the concentrates should be shelf stable when in a closed packaging. Preferably, it would allow the use of such ingredients as herbs, vegetables, fruits, meat, fish, crustaceans and particles thereof in the form of intermediate moisture-stabilised ingredients.

WO 2001/072148 discloses cooking aids which are composed of a meltable or dissolvable wall material, enclosing a fluid or pasty filling. Such liquid or pasty filling would allow the use of non-dry herbs and vegetable (particulates) in its filling. However, the manufacture of such filled cubes can be cumbersome.

JP 61/031,068 discloses soup concentrates for use with instant noodles, which soup concentrate is in the form of a jelly, which concentrate needs to be diluted 5-6 times with water to yield a soup to be consumed or served with noodles. Said jellies are formed with gelatin in combination with one or more of alginate, agar and apple puree. The jellies take 3-6 minutes to dissolve. The jellies in this reference can include meat (pieces) and vegetable (pieces). Although this jelly form allows for non-dry particulates, the jellies disclosed have some disadvantages.

### SUMMARY OF THE INVENTION

There is a need for packaged concentrates for use as seasoning or for preparing a bouillon, broth, soup, sauce, or gravy, which concentrate is in the form of a (packaged) jelly, which jelly can dissolve in boiling water fairly quickly (e.g. a mass of 30 g would dissolve in 900 ml boiling water in less than 3.5 minutes, preferably less than 3 minutes). It is also preferred that such jelly has a low tendency to syneresis (water separation) and is preferably an elastic, not too rigid gel (as such will facilitate removal from its packaging; elastic and not too rigid can best be judged by hand-feel). Also it is desired that preferably the gel is not too sticky (as such gel is likely to be handled by fingers and to allow easy removal from the packaging), and a simple method for manufacturing such (e.g. not too viscous in preparation, or requiring more complex equipment or processing). Preferably, the concentrates should be such that they allow the usual dilution rates (in e.g. an aqueous liquid such as water) for e.g. bouillons (e.g. as in bouillon cubes) like 1:20-1-50 (i.e. allows for high salt levels in the gel). Also, the product should be fairly stable in transport and storage, which is normally at ambient temperatures, but during which temperatures can rise substantially higher. Preferably, the gel should also have a certain strength: preferably the strength should be such that the force (in gram) necessary for a plunger to penetrate 10 mm in a gel is above 50, preferably above 70 g. Also low to no phase separation is desired.

It has now been found that such may be achieved (at least in part) by a packaged concentrate for preparing a bouillon, broth, soup, sauce, gravy or for use as a seasoning, said concentrate comprising:
20-80% water (weight % based on total packaged concentrate),
0.5-0.5-60% by weight of herbs, vegetables, fruits, meat, fish, crustaceans, or particulates thereof, (weight % based on total packaged concentrate),
0.1% to 10% (weight % based on water content of concentrate) of a gelling agent comprising the combination of xanthan and locust bean gum (LBG), xanthan and LBG each being present in an amount of 30-70% on the total amount of xanthan+LBG,
3-30% (weight % based on water content of concentrate, more preferably 15-30%, most preferably 15-26%) of salt,
   wherein the concentrate has the appearance of a gel (preferably judged when taken out of the packaging).

The person of average skill in the art of food products recognizes a gel when he or she sees one. The appearance of a gel generally can be achieved in an aqueousenvironment when sufficient gelling agents are used in the formulation. A gel will usually have a smooth surface appearance, be shape-retaining at ambient temperature when exposed to gravity, but easily deformable (to some degree in an elastic way). More preferably, the packaged concentrate according to the invention (when taken out of the packaging) has the appearance or rheology of a gel as expressed by a ratio of elastic modulus G′: viscous modulus G″ of at least 1, preferably at least 3, more preferably at least 5. It can furthermore be preferred that the viscous modulus G″ is at least 10 Pa, preferably at least 50 Pa. The method of measuring such is described below.

With “herbs, vegetables, fruits, meat, fish, crustaceans, or particulates thereof” is meant particles having a size such that they are at least visible to the naked eye, in the product as consumed, e.g. upon dillution with water in the required dillution rate (as that is when the particulates or herbs etcetera matter: to be seen just prior to consumption). Thus, “meat powder” as known in the bouillon industry can be difficult to be seen in the jelly cube (e.g. due to the concentration, possible turbidity following certain ingredients), but such conventional meat powder particulates are well visible to the naked eye in the soup or bouillon when prepared in the proper dilution.

Water (as amount) is herein to be understood as the total amount of moisture present. The concentration of salt is to be calculated as (amount of salt)/(amount of salt+total moisture).

The same is true for other dissolved matter, such as gelling agent (amount of gelling agent/(amount of gelling agent+total moisture amount).

It can be preferred that the concentrate according to the present invention comprises 15-30% (by weight, based on total water content, more preferably 15-26%) salt (preferably NaCl, but also including other salts, preferably in dissolved form). “Salt” in this context can be sodium chloride but it can also be another alkali metal salt such as potassium chloride, or a mixture thereof, or other low-sodium products that aim for the taste impression of sodium chloride, as long as the taste in the end formulation (e.g. bouillon, or seasoned food product) is acceptable. The upper limit of solubility in water of NaCl is around 26% (at room temperature), and hence above this limit some salt crystals may occur. Hence, the amount of salt is preferably (just) below this salt saturation concentration level.

By the above formulation, concentrates for preparing a bouillon, broth, soup, sauce, gravy or for use as a seasoning can be obtained that are different from the conventionally used dry cubes and tablets, in that the concentrates according to the invention are not dry. It allows the use of herbs, vegetables, meat, fish, crustaceans (or particulates thereof) which are partially wet, i.e. not completely dried. What it shares with conventional bouillon cubes and tablets is that it comes in a unit dose format (i.e. not a bulk product like liquid, powder or granules): a portioned amount, individually packaged.

Notwithstanding the fact that the concentrate according to the present invention allows the use of (piece on herbs, vegetables, meat, fish, crustaceans which are not dry, it is also possible to include such ingredients in dry form in the concentrate according to the present invention. Such dry ingredients may then be to some extent hydrated by the moisture present in the concentrate.

The concentrates are more or less shape stable: it is not an easily flowable product, but it being a gelled product means it can deform (easily) under pressure. By choosing the amount and ratio of xanthan and LBG the desired rheology can be obtained.

The amount and ratio of xanthan and LBG as required will e.g. depend on the amount of salt in the formulation, and such amounts and ratio can be determined by the person of average skill in the art of gelled food products without undue burden. Locust bean gum and xanthan on their own at high salt levels do not really gel, but in combination they do. Typical amounts will be:
at a salt level of 15%: LBG+xanthan (together): 0.15-5%, more preferably 0.4-2%,
at a salt level of 25%: LBG+xanthan (together): 0.2-7%, more preferably 0.6-3%, both as wt % on the amount of water as defined above.

LBG and xanthan are herein preferably used in such amounts that the total amount of LBG+xanthan comprises 30-70% LBG and 30-70% xanthan (wt % on total amount of xanthan+LBG). Preferably, these amounts are 40-60% and 60-40%, respectively, and even more preferred 4-55% and 55-45%, respectively. Most preferred ratio is each component in an amount of about 50% and 50%.

The texture or rheologie desired for the product according to the invention is preferably that of a gel. Regarding a gel, in scientific literature, e.g. “Das Rheologie Handbuch, Thomas Mezger, Curt R. Vincentz-Verlag, Hannover, 2000” a gel is typically defined by its ratio of elastic modulus G′ to viscous modulus G″. This allows it to distinguish between a highly viscous fluid, e.g. a paste and an elastic system of same viscosity e.g. a jelly. This ratio should be greater than 1 for a gel. For the given product, a ratio of greater than 1 is suitable. It is preferred, however, that said ratio is greater than 3, more preferably it is greater than 5.

The absolute value of the viscous modus G″ is preferably greater than 10 Pa, more preferred greater than 50 Pa. This criterion distinguishes between thin solutions with gel character and a more shape retaining jelly products that are the intended products according to this invention.

The above given values need should be measured under the following circumstances:
a maturation time of at least 12 h under ambient conditions,
measurement temperature of 25° C.,
an oscillatory frequency of 1 rad/s and
a strain of 1%.

This set of parameters refers to a standard oscillatory test conducted with a standard state of the art low deformation rheometer as commercially available from e.g. Bohlin or TA Instruments.

The requirements as stated herein for G′: G″ should preferably apply to the whole concentrate (apart from the particulates mentioned), and not just for a part of it. For example, for a construction like in WO 01/72148 such may be true for the wall material, but not for the fluid or pasty core. Also, it is preferred that the concentrate does not consist of a solid envelope material covering core. It can also be preferred that the concentrate is translucent and/or transparent, apart from the visual elements like herbs, vegetables, meat, fish, crustaceans (or particulates thereof). Hence, of the matrix material (e.g. comprising water, a gelling agent, and optionally salt, taste enhancers, oil) further comprising the visual elements like herbs, vegetables, meat, fish, crustaceans (or particulates thereof), the matrix material is preferably transparent and/or translucent.

The concentrate according to the invention is preferably non-sweet, which is characterised by a sweetness as an equivalent to a percentage sucrose of lower than 20%, preferably lower than 15%, even more preferably lower than 10%, most preferably lower than 6%, and resulting in an end-product that is lower in sweetness than 0.5 g/l of sucrose equivalent, preferably below 0.3 g/l of sucrose equivalent, more preferably below 0.2 g/l of sucrose equivalent. The sweetness refers to an equivalent sweetness to sucrose that is calculated via the sweetness index of the used sweeteners. Thus, the concentrate according to the invention has a sweetness as expressed by a sweetness index of below 0.5 g/litre sucrose equivalent, preferably below 0.3 g/l of sucrose equivalent, more preferably below 0.2 gA of sucrose equivalent. The equivalent amount to sucrose refers to an equivalent sweetness to sucrose as it is calculated via the sweetness index of the used sweeteners.

As used herein, “sweetness index” is a term used to describe the level of sweetness of the dosage form relative to sucrose. Sucrose, defined as the standard, has a sweetness index of 1. For example, the sweetness indices of several known sweet compounds are listed below:

Sorbitol 0.54-0.7, Dextrose 0.6, Mannitol 0.7, Sucrose 1.0, High Fructose Corn Syrup 55% 1.0, Xylitol 1.0, Fructose 1.2-1.7, Cyclamate 30, Aspartame 180, Acesulfame K 200, Saccharin 300, Sucralose 600, Talin 2000-3000. Further values and reference literature can be found e.g. in “Römpp Lebensmittelchemie, Georg Thieme Verlag, 1995”.

It can also be preferred that by equivalent sweetness is herein understood the perceived sweetness by a consumer as determined by a trained panel matching the product sweetness to a standard sucrose solution. The detailed method is described in the appropriate DIN standard. For recipe design purposes this shall be assumed similar to the sweetness as calculated by the so called sweetness index.

The herbs, vegetables, meat, fish, crustaceans, or particulates thereof (including mixtures thereof) as applied in the current invention can be intermediate moisture components.

Typically, intermediate moisture ingredients will have a water activity a_{w} of 0.5-0.98, preferably 0.6-0.87, more preferably 0.6-0.75.

### DETAILED DESCRIPTION OF THE INVENTION

In the concentrates according to the present invention the amount of herbs, vegetables, fruits, meat, fish, crustaceans, or particulates thereof is preferably 1-40%, more preferably 1-20%, most preferably 2-20% (by weight on the total packed concentrate).

The total moisture content of the total concentrate according to the present invention as it is in the packaging (i.e. including the particulates of herbs, vegetables, meat, fish, crustaceans) is 20-80% (by weight, based on total packed concentrate), preferably 40 to 60% by weight (based on the total packed concentrate). The water activity a_{w} of the total concentrate as it is in the packaging is preferably 0.5-0.98, more preferably 0.6-0.87, even more preferably 0.7-0.8, and most preferably 0.7-0.75. The pH of the total concentrate according to the invention is preferably between 3 and 8, more preferably 4-7. Such pH can be measured after e.g. finely grinding the whole concentrate. In connection to this, it may be preferred that (organic) acids are present. Such may also be the case for taste reasons.

The concentrate according to the present invention is preferably shelf stable when in its intact packaging. This can be ensured by selecting the appropriate manufacturing process in combination with a correct composition. For example, a process involving a pasteurising step (either explicitly or as part of other process steps), followed by hot or aseptic filling of packaging, and the right water activity a_{w} and pH of the composition may ensure such.

Depending on the ingredients and processing chosen, the concentrate according to the present invention is shelf stable for at least 3 months when in its intact packaging at ambient temperature. Preferably, the concentrate according to the present invention has an open shelf life of at least 3 months at ambient temperature. This can be achieved at high salt levels, e.g. at 20-26% salt (on water basis). Hence, such salt level can be preferred.

Next to the ingredients mentioned, it may be preferred for the concentrates according to the present invention that they further comprise 0.5-30% (weight on total concentrate) of a taste enhancer selected from the group of monosodium glutamate, 5′-ribotides, organic acids, or mixtures thereof. Salt can also be seen as a taste enhancer, but is herein regarded as a separate category of ingredients.

Fats and/or oils may be used as an ingredient in the concentrates according to the present invention. They may contribute to flavour and/or mouthfeel. Due to the aqueous nature of the concentrates, such fat is preferably present in an emulsified or dispersed form. Use of emulsifers and/or stabilisers may be desired. Hence, it may be preferred that the concentrate according to the present invention further comprises 1-30% (weight on total packaged concentrate) of emulsified or dispersed oil and/or fat, preferably 1-15%.

As the concentrates are jelly-like, they can have a shape. Preferably, the concentrate according to the invention is in the form of a cube, tablet, brick-shape, pellet, ball (sphere), briquette, dragee, egg-shape, or flattened egg-shape. It is herein to be understood that “cubes or tablets” and “unit dose” encompass a wide variety of geometric shapes: next to cubes and tablets also pellets, briquettes, brick-like shapes, etcetera. Each individual gelled concentrate preferably is of a size such that the concentrate has a weight (excluding packaging) of 1-10 kg, preferably 2-250 g, more preferably 10-50 g. The portion of the concentrate according to the present invention as packaged is preferably such that the concentrate has a weight excluding packaging) of 1-10 kg, preferably 2-250 g, more preferably 10-50 g. The packaging can be e.g. a blister pack or a glass or plastic jar or (sealed) tubs or cups. Preferably, in the packaged concentrate according to the invention the container is a cup or tub with a seal, but also more complex packaging shapes are now possible (e.g. a reclosable pack). A specific and preferred packaging option are sealed or reclosable cups or tubs (e.g. plastic cups e.g. having a volume of 1-250 ml, comprising 1-250 g, preferably 2-50 g (more preferably 10-50 g) concentrate, which are closed with a lid or seal, preferably a seal of sheet-like material).

The packaged concentrates according to the present invention are preferably translucent or transparent. This can also make it attractive to choose e.g. packaging which is at least partially transparent.

The invention further relates to a process for the preparation of the concentrates according to the present invention. A process for the preparation may comprise the steps of mixing the ingredients with the water, filling into the packaging (e.g. blister packs or cups or tubs) and closing the packs (e.g. by a seal), whereby preferably a heating step is applied prior to, during or after filling into the packaging, for preservation purposes and/or to facilitate dissolution of ingredients and/or achieving gelation (upon cooling thereafter) of thermoset gels. Alternatively, the (heated) mixture may be poured in moulds, cooled to set. After setting to a gel, the gelled concentrate will have to be removed from the moulds and packaged. It is preferred, however, to manufacture directly into the packaging. It is preferred that the steps of mixing the ingredients with the water, filling into the packaging and closing the packaging, whereby a heating step is applied prior to, and/or during and/or after filling into the packaging.

In the above process, it is preferred that at least part of the heating stage is to a temperature of at least 80° C. Also, it is preferred that the temperature of the mixture during the filling is at least 70° C. When fat is used solid at room temperature, it is preferably melted first before adding to other components.

The invention further relates to the use of a concentrate as set out above, for preparing a bouillon, broth, soup, sauce, gravy or for use as a seasoning. This may be done by diluting with an aqueous liquid (e.g. water) under application of heat, in e.g. a ratio of 1:15-1:100, preferably 1:20-1:70, more preferably 1:20-1:50.

The invention further relates to the use of the concentrate according to the present invention and as set out above for preparing a bouillon, broth, soup, sauce, gravy or for use as a seasoning. Such use e.g. implies removing the concentrate from its packaging, and adding it to food or a dish, either during or after its preparation, optionally further applying heat and/or stirring the food or dish with such concentrate.

### EXAMPLES

### Example 1

### Medium Salt Jelly with Xanthan+LBG and Fresh Vegetables

| | Recipe Dry |
|---|---|
| | Base Mix |
| Ingredient | kg |
| vegetable flavour | 7.500 |
| yeast extract | 1.200 |
| IG | 0.400 |
| Sugar | 8.000 |
| MSG | 8.000 |
| Salt | 10.000 |
| Spices | 2.400 |
| vegetable powders | 3.200 |
| Acidifier | 1.000 |
| | 41.70 |
| | Recipe Jelly |
| Ingredient | kg |
| Dry Base Mix | 41.700 |
| Water | 50.000 |
| Xanthan | 0.500 |
| LGB | 0.500 |
| frozen vegebles | |
| Carrot grits | 6.000 |
| Parsley leaves frozen | 3.000 |
| Leek pieces | 5.000 |
| Onion pieces frozen | 7.000 |
| | 113.700 |

### Process Dry Mix

Add all dry ingredients into a Lödige Mixer
Mix dry powders at 120 rpm without chopper for 5 min until homogeneous
Pack into plastic bags
Close and store at ambient temperature

### Process Jelly

Add water into a vessel (Unimix)
Add xanthan and LBG
Continue mixing for 30 min
Add dry mix and mix still homogeneous

### Heat up to 95° C.

Add frozen vegetables

### Heat up to 95° C.

### Keep at 95° C. for 5 min

Hot filling into glass jars of 50 ml
Capping of glass jars
Cooling down at room temperature for 24 h.

### Example 2

### High Salt Jelly with Xanthan+LBG

| | Recipe Dry |
|---|---|
| | Base Mix |
| Ingredient | Kg |
| Chicken flavour | 8.400 |
| Chicken meat powder | 3.000 |
| Yeast extract | 1.200 |
| IG | 0.400 |
| Carrot grits | 0.900 |
| Sugar | 10.200 |
| Onion pieces | 3.000 |
| Leek pieces | 1.000 |
| Maltodextrin | 8.500 |
| MSG | 17.000 |
| Parsley leaves | 1.300 |
| Salt | 35.000 |
| Spices | 2.400 |
| Vegetables powders | 1.700 |
| Potato starch | 6.000 |
| | 100.00 |
| | Recipe Jelly |
| Ingredient | Kg |
| Chicken flavour | 8.400 |
| Chicken meat powder | 3.000 |
| Yeast extract | 1.200 |
| IG | 0.400 |
| Carrot grits | 0.900 |
| Sugar | 10.200 |
| Onion pieces | 3.000 |
| Leek pieces | 1.000 |
| Maltodextrin | 8.500 |
| MSG | 17.000 |
| Parsley leaves | 1.300 |
| Salt | 35.000 |
| Spices | 2.400 |
| Vegetables powders | 1.700 |
| Potato starch | 6.000 |
| | 100.00 |

### Process Dry Mix

Add all dry ingredients into a Lödige Mixer
Mix dry powders at 120 rpm without chopper for 5 min until homogeneous
Pack into plastic bags
Close and store at ambient temperature

### Process Jelly

Add water into a vessel (Unimix)
Add xanthan and LBG
Continue mixing for 30 min
Add dry mix and mix still homogeneous

### Heat up to 90° C.

### Keep at 90° C. for 10 min

Hot filling into glass jars of 40 ml
Capping of glass jars
Cooling down at room temperature for 24 h.

The resulting products of both examples 1 and 2 had the appearance of a gel and were shape stable.

### Example 3

### Dry Mix (g)

375 g salt
200 g palm fat

### 175 g MSG

27.45 g flavouring components, spices and taste enhancers

### Vegetable Mix (g):

220 g frozen grated carrots
110 g frozen grated leek
70 g frozen grated spinach
50 g frozen grated bell pepper
30 g frozen grated pumpkin
20 g frozen grated celery
15 g frozen grated corn

### Gelling System:

700 g water
8 g xanthan

### 3.5 g LBG

A product was made by mixing all ingredients, heating to 80° C., pouring in moulds and cooling to set. The resulting product looked like a gel, was shape stable, and 15 g of the gel dissolved in less than 2 minutes when immersed in boiling water dilution 30 times).

Examples 4-7: several bouillon concentrates have been prepared with varying taste according to the recipes as described below. Moisture was added as water, all other ingredients are used in a dry form (that is: commercially dry, which usually means for such ingredients 1-3% of moisture). The a_{w} and G′ and G″ have been measured: these results are given after example 4. All four products appeared as gels.

### Example 4

### Beef Jelly with LBG+Xanthan

| | | Amount [g] |
|---|---|---|
| Description | Amount [%] | for 10 kg |
| Sugar | 2 | 0.2 |
| Salt | 18.4 | 1.84 |
| Flavour | 4.9 | 0.49 |
| Citric Acid powder | 0.5 | 0.05 |
| Vegetable powder | 0.45 | 0.045 |
| Yeast extract | 1.5 | 0.15 |
| Spices | 0.2 | 0.02 |
| 5′-ribotides | 0.2 | 0.02 |
| MSG | 5.1 | 0.51 |
| Palm fat | 10.5 | 1.05 |
| Water | 55.38 | 5.535 |
| Xanthan | 0.3 | 0.03 |
| Locus Bean Gum | 0.3 | 0.03 |
| Total | 100 | 10 |

### Process Description:

1. Mix all dry ingredients in a Hobart Mixer till homogeneous

### 2. Melt fat at 60° C.

3. Add melted fat to the dry ingredients and mix in the Hobart mixer until homogeneous
4. Add mix into a double jacket vessel (Unimix type)
5. Add water into the vessel and close the vessel.
6. Heat up to 90° C. while stirring
7. Keep at 90° C. for 3 min while stirring
8. Hot filling into oval tubs of 35 ml size, followed by sealing and leaving to cool to room temperature.

### Example 5

### Fish Jelly with LBG+Xanthan

| | | Amount [g] |
|---|---|---|
| Description | Amount [%] | for 10 kg |
| Fish powder | 8 | 0.8 |
| Flavour | 0.5 | 0.05 |
| Palm fat | 5.8 | 0.58 |
| Creamer powder | 16.1 | 1.61 |
| Spices | 0.1 | 0.01 |
| Lactid acid (liquid) | 0.6 | 0.06 |
| Water | 40 | 4 |
| Modified starch | 3.5 | 0.35 |
| Salt | 13.1 | 1.31 |
| MSG | 4.4 | 0.44 |
| Locus Bean Gum | 0.5 | 0.05 |
| Xanthan | 0.5 | 0.05 |
| Sugar | 6.6 | 0.66 |
| 5′-ribotides | 0.2 | 0.02 |
| Caramel powder | 0.1 | 0.01 |
| Total | 100 | 10 |

### Process Description:

1. Mix all dry ingredients in a Hobart Mixer till homogeneous

### 2. Melt fat at 60° C.

3. Add melted fat to the dry ingredients and mix in the Hobart mixer until homogeneous
4. Add mix into a double jacket vessel (Unimix type)
5. Add water and lactic acid into the vessel and close the vessel.
6. Heat up to 90° C. while stirring
7. Keep at 90° C. for 3 min while stirring
8. Hot filling into oval tubs of 35 ml size, followed by sealing and leaving to cool to room temperature.

### Example 6

### Chicken Jelly (LBG+Xanthan)

| | | Amount [g] |
|---|---|---|
| Description | Amount [%] | for 10 kg |
| Chicken extract | 3.2 | 0.32 |
| Chicken meat powder | 7.3 | 0.73 |
| Chicken fat | 16.1 | 1.61 |
| Spices | 0.4 | 0.04 |
| Water | 44.4 | 4.44 |
| Flavour | 1.3 | 0.13 |
| Salt | 17.3 | 1.73 |
| MSG | 4 | 0.4 |
| Locus Bean Gum | 0.5 | 0.05 |
| Xanthan | 0.5 | 0.05 |
| Sugar | 4.8 | 0.48 |
| 5′-ribotides | 0.2 | 0.02 |
| Total | 100 | 10 |

### Process Description:

1. Mix all dry ingredients in a Hobart Mixer till homogeneous

### 2. Melt fat at 60° C.

3. Add melted fat to the dry ingredients and mix in the Hobart mixer until homogeneous
4. Add mix into a double jacket vessel (Unimix type)
5. Add water and lactic acid into the vessel and close the vessel.
6. Heat up to 90° C. while stirring
7. Keep at 90° C. for 3 min while stirring
8. Hot filling into round tubs of 15 ml size, followed by sealing and leaving to cool to room temperature.

### Example 7

### Pork Jelly with LBG+Xanthan

| | | Amount [g] |
|---|---|---|
| Description | Amount [%] | for 10 kg |
| Pork Flavour | 1.5 | 0.15 |
| Water | 41.5 | 4.15 |
| Pork fat | 12.1 | 1.21 |
| Pork meat powder | 6.1 | 0.61 |
| Salt | 13.6 | 1.36 |
| MSG | 5.3 | 0.53 |
| Locus Bean Gum | 0.5 | 0.05 |
| Xanthan | 0.5 | 0.05 |
| Sugar | 3.8 | 0.38 |
| Palm fat | 3 | 0.3 |
| Pork bone powder | 12.1 | 1.21 |
| Total | 100 | 10 |

### Process Description:

1. Mix all dry ingredients in a Hobart Mixer till homogeneous

### 2. Melt fat at 60° C.

3. Add melted fat to the dry ingredients and mix in the Hobart mixer until homogeneous
4. Add mix into a double jacket vessel (Unimix type)
5. Add water into the vessel and close the vessel.
6. Heat up to 90° C. while stirring
7. Keep at 90° C. for 3 min while stirring
8. Hot filling into round tubs of 15 ml size, followed by sealing and leaving to cool to room temperature

Results examples 4-7: ratio G′/G″ at 21° C. (ambient, as measured following the instructions in the description):

| | Storage | Loss | | | | | |
|---|---|---|---|---|---|---|---|
| | modulus G′ | modulus G″ | Ratio | | Dillution | Dillution | |
| Recipe | (Pa) | (Pa) | G′/G″ | a_{w} | rate | time (s) | syneresis |
| Beef | 75.48 | 14.41 | 5.24 | 0.68 | 28 | 90 | Low |
| Fish | 1061.50 | 186.70 | 5.69 | 0.74 | 26 | 180 | Very low |
| Chicken | 187.50 | 39.55 | 4.74 | 0.73 | 29 | 120 | Low |
| Pork | 466.29 | 100.38 | 4.65 | 0.73 | 30 | 90 | Very low |

The gel strength was measured using the following method:
using a texture analyser from Microstable Sytems, model TA XT2 with 5 kg load cell.
Plunger Diameter (according AOAC method) 0.5 inches means 12.7 mm, height 35 mm, plane surface, sharp edges, material plastics.
Sample Containers have an influence on results if not very large. Therefore the choosen container should always be the same. We have used plastic containers for model systems (diameter bottom 5.5 cm; diameter top 6.5 cm; height 8.5 cm) and glass jars for process trials with recipes other than model systems (diameter 7 cm; height 4 cm).
After preparation, samples have been stored at ambient conditions (21° C.) at least over night before measurement.
TA-Parameters: Pre speed 1 mm/s, Test speed 0.5 mm/s, Re speed 10 mm/s, Distance 15 mm, Trigger Auto, Force 0.5 g, Stop recording at target. Result we take from the recorded graph is force at 10 mm penetration depth (should be in N, but simplified in g).

1. Packaged concentrate for preparing a bouillon, broth, soup, sauce, gravy or for use as a seasoning, said concentrate comprising:
20-80% water (weight % based on total packaged concentrate),
0.5-60% by weight of herbs, vegetables, fruits, meat, fish, crustaceans, or particulates thereof, (weight % based on total packaged concentrate),
0.1% to 10% (weight % based on water content of concentrate) of a gelling agent comprising the combination of xanthan and locust bean gum (LBG), xanthan and LBG each being present in an amount of 30-70% on the total amount of xanthan+LBG,
15-30% (weight % based on water content of concentrate of salt,
wherein the concentrate has the appearance of a gel.

2. Concentrate according to claim 1, wherein the concentrate has the rheology of a gel.

3. Concentrate according to claim 1, wherein concentrate has the appearance or rheology of a gel as expressed by the ratio of elastic modulus G′: viscous modulus G″ of at least 3.

4. Concentrate according to claim 3, wherein viscous modulus G″ is at least 10 Pa.

5. Concentrate according to claim 4, wherein the viscous modulus G″ is at least 50 Pa.

6. Concentrate according to claim 1, wherein the amount of a gelling agent comprising the combination of xanthan and locust bean gum (LBG) is 0.6-3%.

7. Concentrate according to claim 1, wherein xanthan and LBG each being present in an amount of 40-60% of the total amount of xanthan+LBG.

8. Concentrate according to claim 1, wherein the total moisture content of the concentrate is 40-60% by weight (based on the total packed concentrate).

9. Concentrate according to claim 1, wherein, the concentrate has a water activity a_{w} of 0.7-0.8.

10. Concentrate according to claim 1, further comprising 0.5 to 30% (weight on total concentrate) of a taste enhancer selected from the group of monosodium glutamate, 5′-ribotides, organic acids, or mixtures thereof.

11. Concentrate according to claim 1, further comprising 1-15% (weight on total packaged concentrate) of emulsified oil and/or fat.

12. Concentrate according to claim 1, wherein the concentrate is in the form of a cube, tablet, pellet, ball, briquette, dragee.

13. Concentrate according to claim 1, wherein the concentrate is packaged in a cup or tub with a seal.

14. Process for preparing a concentrate for preparing a bouillon, broth, soup, sauce, gravy or for use as a seasoning, said concentrate comprising:
20-80% water (weight % based on total packaged concentrate),
0.5-60% by weight of herbs, vegetables, fruits, meat, fish, crustaceans, or particulates thereof, (weight % based on total packaged concentrate),
0.1% to 10% (weight % based on water content of concentrate, preferably 0.2-7%, more preferably 0.6-3%) of a gelling agent comprising the combination of xanthan and locust bean gum (LBG), xanthan and LBG each being present in an amount of 30-70% on the total amount of xanthan+LBG,
15-30% (weight % based on water content of concentrate) of salt,
wherein the concentrate has the appearance of a gel, the process comprising the steps of mixing the ingredients with the water, filling into the packaging and closing the packs, whereby preferably a heating step is applied prior to, during or after filling into the packaging.

15. Process according to claim 14, wherein at least part of the heating stage is to a temperature of at least 70° C.

16. Use of a concentrate according to claim 14, for preparing a bouillon or soup.
